(19) United States
(12) Patent Application Publication
(10) Pub. No.: US 2008/0010123 A1
(43) Pub. Date: Jan. 10, 2008

(54) SYSTEM AND/OR METHOD FOR EMPLOYING STIMULI IN THE MARKETING OF PRODUCTS

(76) Inventors: Gene Fein, Lenox, MA (US); Edward Merritt, Lenox, MA (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 11/426,552

(22) Filed: Jun. 26, 2006

(51) Int. Cl. G06Q 30/00

(52) U.S. Cl. 705/14

(57) ABSTRACT

Embodiments of methods, devices and/or systems for employing stimuli into the market process of products including bottled water are described

### FIELD

This disclosure is related to the production, packaging, distribution, sales and/or consumption of products including consumable water products, such as bottled water.

### BACKGROUND

For a variety of reasons, it may be desirable to employ stimuli in the market process for particular types of products.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 illustrates one embodiment of a system and/or method of introducing stimuli into the marketing of products which may be employed in one or more embodiments;

FIG. 2 illustrates one embodiment of a system and/or method of introducing stimuli into the marketing of products which may be employed in one or more embodiments;

FIG. 3 illustrates one embodiment of a shipping container that may be employed in one or more embodiments;

FIG. 4 illustrates one embodiment of a system and/or method of introducing stimuli into the marketing of products which may be employed in one or more embodiments;

FIG. 5 illustrates one embodiment of a commercial container that may be employed in one or more embodiments;

FIG. 6 illustrates one embodiment of a distribution container that may be employed in one or more embodiments;

FIG. 7 illustrates one embodiment of a sink that may be employed in one or more embodiments;

FIG, 8 illustrates one embodiment of a drinking glass that may be employed in one or more embodiments;

FIG. 9 illustrates one embodiment of a container that may be employed in one or more embodiments;

FIG. 10 illustrates a flow diagram illustrating one embodiment of a method for introducing stimuli into the marketing of products.

### DETAILED DESCRIPTION

In the following detailed description numerous specific details are set forth to provide a thorough understanding of claimed subject matter. However, it will be understood by those skilled in the art that claimed subject matter may be practiced without these specific details. In other instances, well-known methods, procedures, components and/or subsystems have not been described In detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” and/or “an embodiment” in various places throughout this specification are not necessarily all referring to the same embodiment. Furthermore, the particular features, structures, and/or characteristics may be combined in one or more embodiments.

“Marketing” as referred to herein relates to one or more phases of the production, packaging, distribution, sales and/or consumption of products, For example, bottled water may comprise a product. Bottled water may be brought from a source, through the packaging process to consumption by a consumer by employing one or more of these above-noted phases. In one example, water may be obtained from a spring, or from some other source such as a reservoir or cistern. The water may be marketed by being processed, packaged, distributed, sold, and eventually consumed by a consumer in any manner including drinking, use in a sauna or steam room, swimming pool, used as part of a blessing, for irrigation, bathing, medicinal use, formation of ice, watering of plants and/or animals, display as well as additional uses not listed in detail. However, these are just examples, and any process and/or action that may bring a product from source material to consumption may be considered marketing in this context. Similarly, any use of a product by a consumer may be considered consumption in this context.

As alluded to previously, it may be desirable, for a variety of reasons, to introduce a stimulus or stimuli into the marketing of products. In one embodiment, the products may comprise water products such as bottled water. However, other such embodiments may be directed toward products including water, such as beverages including water-based beverages and foods, to name a few categories of products. Stimuli may include visual, audible, physical or other sensory stimuli. In at least one embodiment, the stimuli comprise “positive” stimuli. Positive stimuli may include a stimulus or group of stimuli that may be characterized as generally having a desired connotation, such as a display of certainty, acceptance, or affirmation. For example, positive stimuli may comprise visual stimuli, such as words and/or symbols having a positive connotation such as “love” “gratitude”, “happy”, “thank you”, and “overjoyed”, to name a few examples. Each particular words and/or symbols may be in a language other than English, in alternative embodiments. A positive stimulus may additionally comprise an audible stimulus, such as music. The music may include classical music including Mozart, audible stimuli such as chanting or choir, music employing classical instruments such as harps, spoken words having positive connotations. However, it is worthwhile to note that these are merely examples of a positive stimulus, and other types and categories of positive stimuli may be employed in accordance with one or more embodiments.

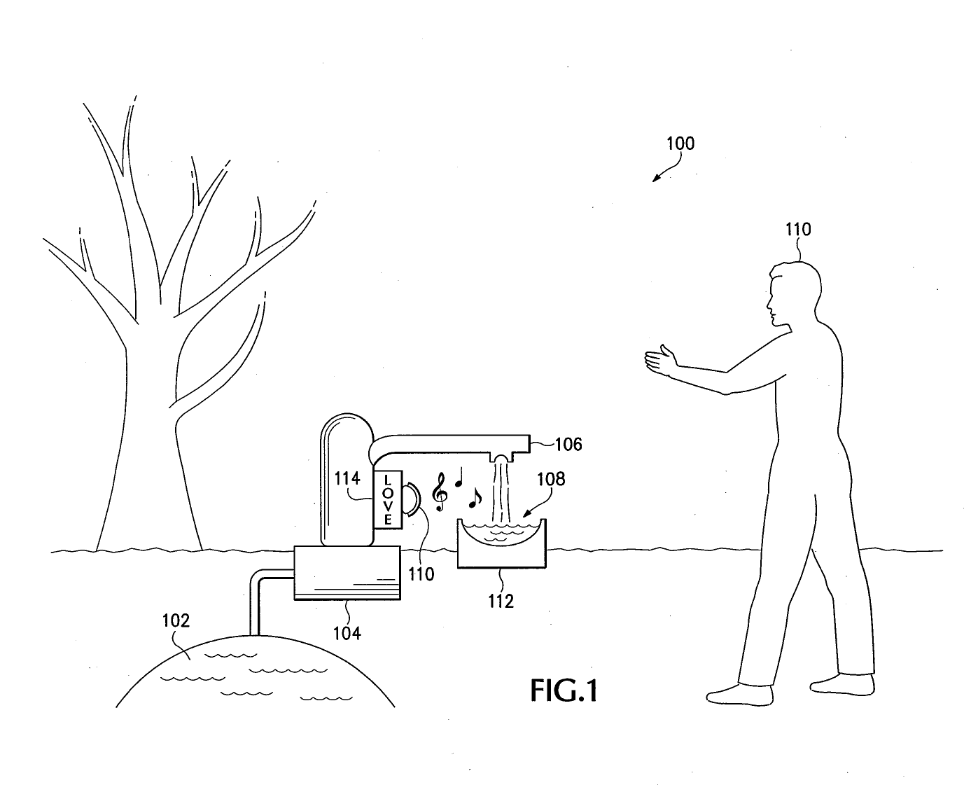

A stimulus may be employed in one or more phases of the marketing of products such as water, and may be employed in a variety of ways. The stimulus may be employed such that the water is continually exposed to one or more forms of stimulus at multiple marketing phases, such as during the obtaining or production, packaging, distribution, sales and/or consumption of the water. For example, referring now to FIG. 1, there Is illustrated a system and/or method of introducing stimuli into the marketing of products that may be employed in one or more embodiments. FIG. 1 comprises a system 100 for obtaining and distributing spring water 108. In this embodiment, the spring water is obtained from a spring water supply 102, which may comprise a spring, or other source such as a reservoir or cistern. Spring water 108 may be pumped from the water supply 102 by use of a network of pipes or pumps 104. The spring water 108 may be provided to a basin 112 after passing through a faucet 106. In this embodiment, stimuli 110 and 114 may be included in the process of providing the spring water 108 from water supply 102 to faucet 106 and into basin 112. For example, an audible stimulus 110 such as music, chanting, blessings or positive words may be provided, and/or a visual stimulus such as words or symbols 114 may additionally be provided on or near the water, such as on the inside of pipes or pumps 104. Stimuli 110 and 114 may be provided in a variety of methods and at a variety of locations, but claimed subject matter is not limited in this respect. In this example, positive stimuli in the form of music and words, such as described previously, may be provided at the outlet of the faucet or tap 106, proximate to basin 112, and may be provided at other locations such as on or near water supply 102 or network of pipes or pumps 104.

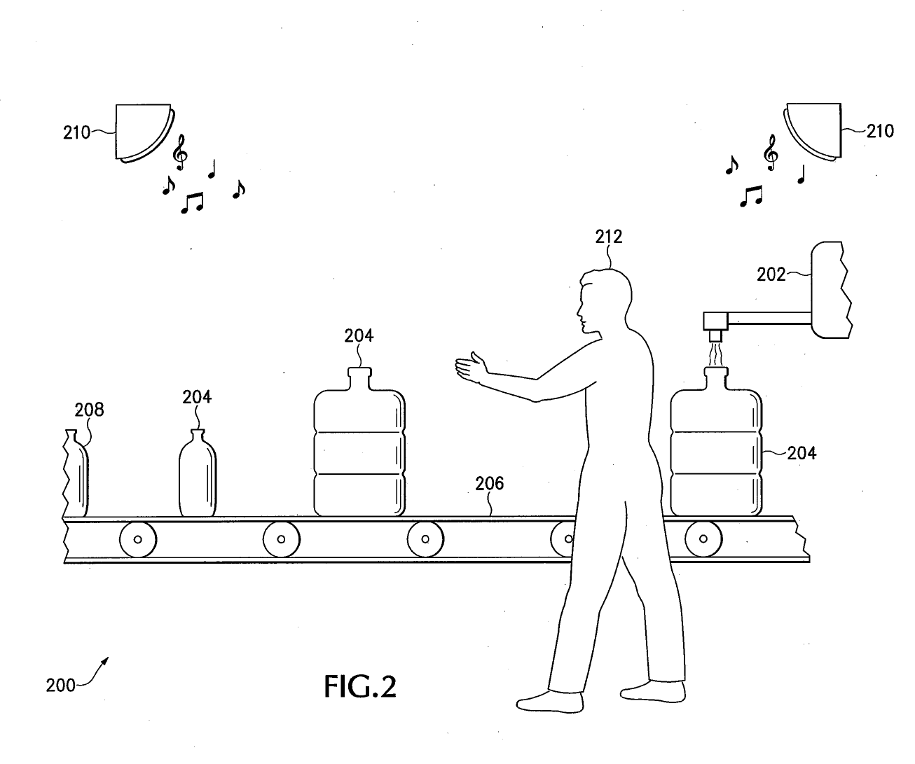

Referring now to FIG. 2, there is illustrated a system and/or method of employing stimuli into the marketing of products according to particular embodiments. FIG. 2 comprises a system 200 for packaging water, which may include labeling of such packaged water. In this embodiment, water dispenser 202 dispenses water into containers 204. Containers 204 may comprise bottles or jugs, for example. Containers 204 move along a conveyor 206, to a labeler or presser 208, not illustrated in detail. Labeler or presser 208 may dispose a label (not shown) on the containers 204, or may emboss or press labeling into the containers 204 by deforming the container material. In this embodiment, a stimulus may be included in the system 200, and may include an audible stimulus such as music, chanting, blessings or positive words generally having a positive connotation. The audible stimulus may be provided by speakers 210 and/or a person 212, who may be proximate to the containers 204, for example.

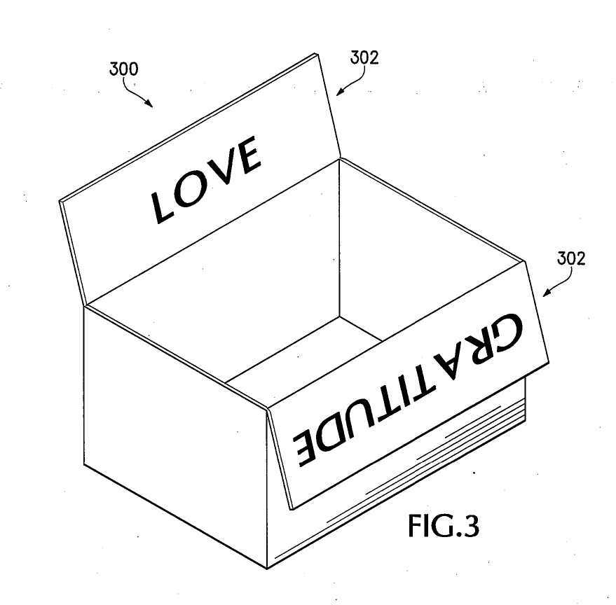

Referring now to FIG. 3, shipping box 300 may be adapted to be packed with containers of water, such as containers 204 of FIG. 2, for example, according to a particular embodiment. Shipping box 300 may include a stimulus in the form of words 302, words having positive connotations including “love” and “gratitude” in this particular embodiment. However, other visual, audible, or physical stimuli may be employed in alternative embodiments.

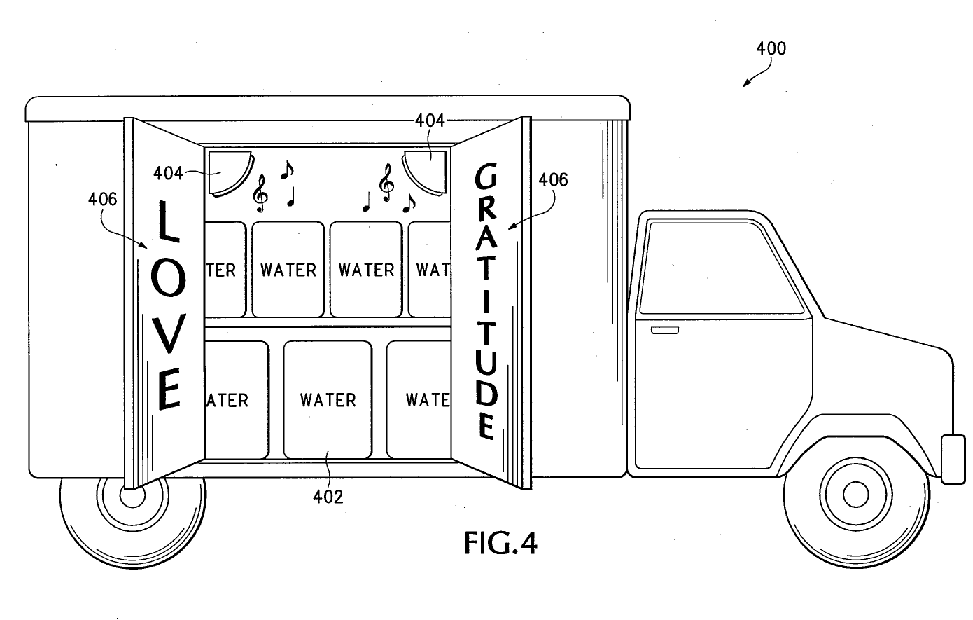

FIG. 4 illustrates a method and system of employing positive stimuli to bottled water during transport of the bottled water. Illustrated in FIG. 4 is transport vehicle 400. Transport vehicle 400 may be adapted to transport containers of water (not shown) that may be packed in shipping boxes 402. Shipping boxes 402 may be substantially similar to box 300 of FIG. 3, for example. Transport vehicle may be adapted to produce a stimulus, such as an audible stimulus by the use of speakers 404. Additionally, a stimulus in the form of words 406, in this embodiment, “love” and “gratitude” may be disposed on the doors of transport vehicle 400. Speakers 404 may be adapted to produce an audible stimulus such as music, chanting, blessings or positive words having positive connotations, for example. However, other visual, audible, or physical stimuli may be employed in alternative embodiments.

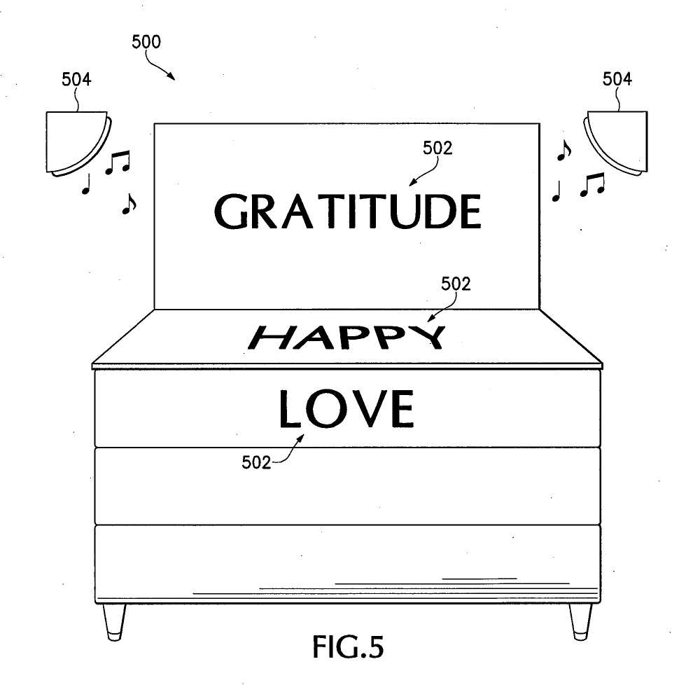

FIG. 5 illustrates a retail display 500 that may be employed in the marketing of products such as bottled water. In this embodiment, retail display 500 may be adapted to store, display or hold containers of water, such as bottled water packaged for retail purchase. Retail display 500 may include a stimulus in the form of words 502, in this embodiment, “love”, “happy” and “gratitude”, and may additionally include an audible stimulus such as music, chanting, blessings or positive words that may be provided by use of speakers 504, for example. The various stimuli may have positive connotations in at least one embodiment. However, other visual, audible, or physical stimuli may be employed in alternative embodiments.

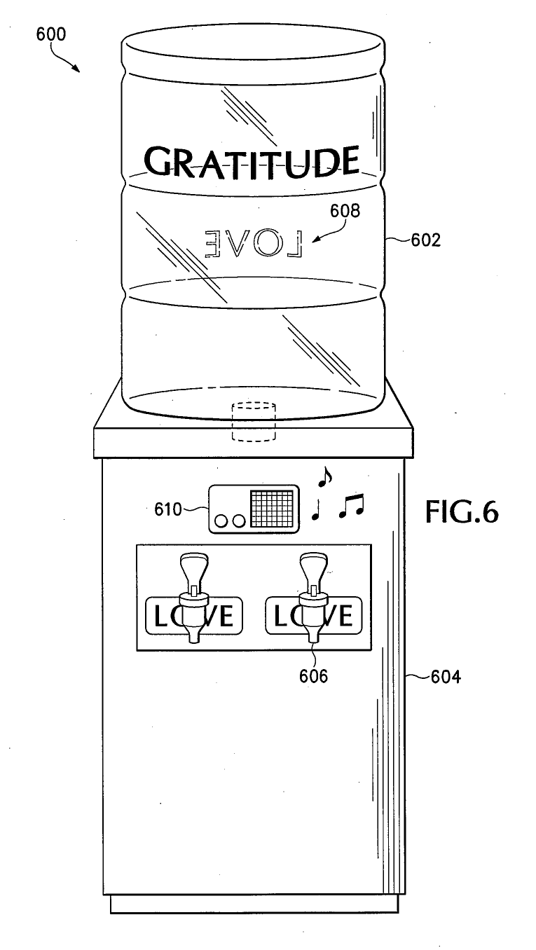

FIG. 6 illustrates a water cooler 600 that may distribute water in a particular embodiment. Here, water cooler 600 includes a container 602, and a base 604 having one or more spigots 606. Water cooler 600 may provide a stimulus 608, which may be in the form of words, in this embodiment, “love” and “gratitude”, and may be formed on container 602, and may additionally be formed on or near the one or more spigots 606. Additionally, an audible stimulus such as music, chanting, blessings or positive words may be provided by use of an audio system 610 formed on base 604. The audio system 610 may be activated when one of the spigots 606 is manipulated, for example. Resulting stimuli may have positive connotations in at least one embodiment. However, other visual, audible, or physical stimuli may be employed in alternative embodiments.

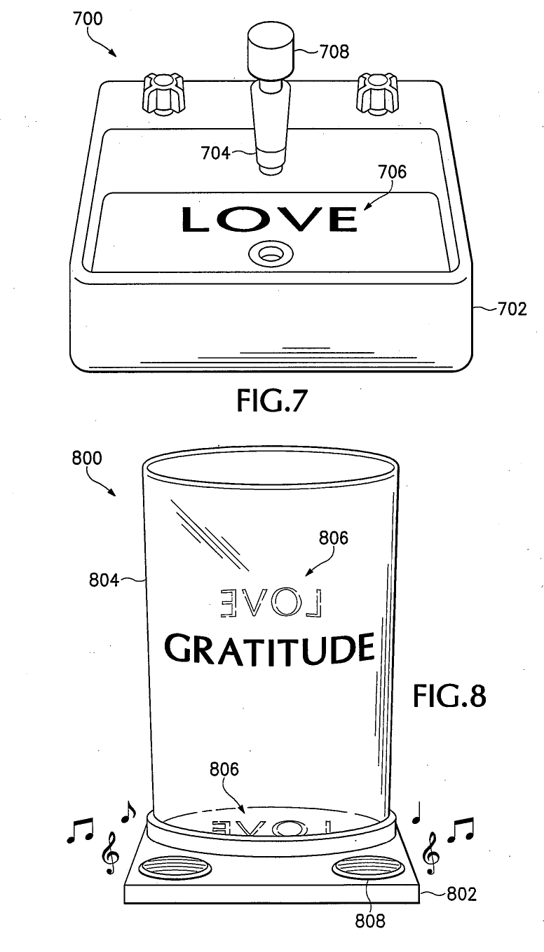

FIG. 7 illustrates a sink 700 that may be employed to distribute water. In this embodiment, sink 700 includes a basin 702 and a faucet 704. Sink 700 may display words 706, in this embodiment, “love” maybe formed on the basin 702, but additional words may be disposed on other regions of sink 700 in alternative embodiments. Additionally an audible stimulus such as music, chanting, blessings or positive words may be provided by use of an audio system 708 formed on or near faucet 704. The audio system 708 may be activated when faucet 704 is manipulated to provide water, for example. The various stimuli may have positive connotations in at least one embodiment. However, other visual, audible, or physical stimuli may be employed in alternative embodiments.

FIG. 8 illustrates a drinking glass 800 and a base 802 adapted to receive a drinking glass. Drinking glass 800 may include a stimulus in the form of words 806, in this embodiment, “love”, and “gratitude” may be formed on one or more surfaces of drinking glass 800. However, additional words may be disposed on other regions of glass 800 in alternative embodiments. Base 802 may additionally have a positive stimulus such as words 806 disposed thereon, and may be adapted to produce an audible stimulus such as music, chanting, blessings or positive words by use of an audio system 808 formed on base 802. Audio system 808 may be activated when drinking glass 800 is coupled to base 802, in response to pressure, for example. Alternatively, base 802 may be adapted to determine whether drinking glass 800 contains water 804 therein, and may activate audio system 808 if sufficient water is determined to be present, for example. The various stimuli may have positive connotations in at least one embodiment. However types or categories of visual, audible, or physical stimuli may be employed in alternative embodiments,

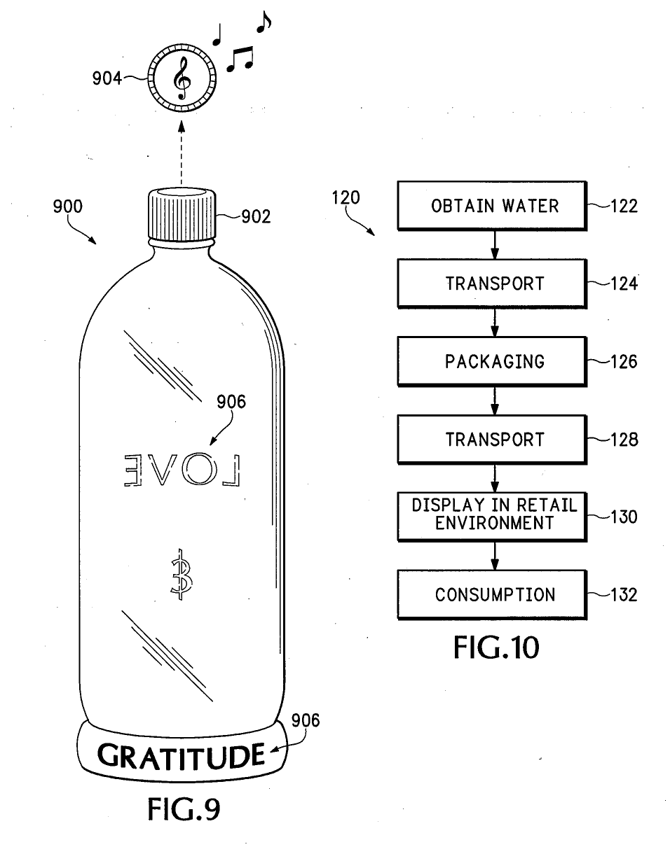

FIG. 9 illustrates a bottle 900 that may be adapted to contain water. Bottle 900 may include a positive stimulus in the form of words 906, in this embodiment, “love”, and “gratitude” may be formed on one or more surfaces of bottle 900. However, additional words may be disposed on other regions of bottle 900 in alternative embodiments. Bottle 900 may additionally include a cap 902. Cap 902 may additionally have a positive stimulus such as words formed thereon, and may be adapted to produce an audible stimulus such as music, chanting, blessings or positive words by use of an audio system 904 formed integrally with cap 902. In one embodiment, cap 902 may comprise a pressure sensitive cap including an audio system 904. Audio system 904 may be activated in response to cap 902 being removed from bottle 900 to produce an activatible audio stimulus, for example. The various stimuli may have positive connotations in at least one embodiment. Additionally, other types or categories of visual, audible, or physical stimuli may be employed in alternative embodiments.

FIG. 10 is a flow diagram of an embodiment 120 of a process for Introducing stimuli into the marketing of products, such as stimuli having positive connotations. However, claimed subject matter is not limited in scope to this particular example. For example, for flow diagrams presented herein, the order in which blocks are presented does not necessarily limit claimed subject matter to any particular order. Additionally, intervening blocks not shown may be employed without departing from the scope of claimed subject matter,

Continuing with FIG, 10, at block 122, water may be obtained from a spring, or from some other source such as a reservoir, well or cistern, for example. During the obtaining of the water, stimuli may be introduced or disposed proximate to the water being obtained, and may include audible, physical or sensory stimuli that may have positive connotations. In one embodiment, as described with reference to FIG. 1, water may be pumped from the water supply by use of a network of pipes or pumps, and provided to a basin after passing through a faucet. A positive stimulus such as music, chanting, blessings or spoken words may be provided, and/or a visual stimulus such as words or symbols. These various stimuli may be provided at the outlet of a faucet proximate to the basin and/or other locations such as on or near the water supply or network of pipes or pumps.

At block 124, the obtained water may be transported for packaging. During the transporting of the water, positive stimuli may be introduced, and may include audible, physical or sensory stimuli that may have positive connotations. In one embodiment, as described with reference to FIG. 4, a transport vehicle adapted to transport the water may provide positive stimuli. For example, the transport vehicle may comprise a tanker truck having a tanker portion adapted to contain water. The tanker truck, such as the tanker portion may include a positive stimulus, such as in the form of words, in this embodiment, “love” and “gratitude” disposed on an inside surface of the tanker portion. Additionally, an audible stimulus such as music, chanting, blessings or positive words may be provided by use of speakers that may be proximate to the tanker, for example.

At block 126, the transported water is packaged, such as by being bottled at a bottling facility. During packaging, positive stimuli may be introduced, and may include audible, physical or sensory stimuli that may have positive connotations. In one embodiment, as described with reference to FIG. 2, a packaging system includes a water dispenser that may dispense water into containers. The containers may comprise bottles or jugs, for example. The containers are actuated along a conveyor, and may be moved to a labeler or presser. The labeler or presser may be employed to dispose a label on the containers, or may be employed to emboss or press labeling into the containers by deforming the container material. The label may include a visual stimulus, as described previously. Stimuli introduced into the system may include an audible stimulus such as music, chanting, blessings or spoken words, and may be provided by use of speakers and/or a person that may be proximate to the containers, for example.

At block 128, the packaged water is transported to a retail environment. During the transportation of the water, positive stimuli may be introduced, and may include audible, physical or sensory stimuli that may provide positive connotations. In one embodiment, as described with reference to FIG. 4, a transport vehicle may be adapted to transport the water, and the transport vehicle includes positive stimuli. For example, the transport vehicle may be capable of hauling boxes of the packaged water. In a particular embodiment, “love” and “gratitude” may be disposed on the inside of the truck, or the bottled water may be boxed in containers having words such as these disposed thereon. Additionally, an audible stimulus such as music, chanting, blessings or positive words may be provided by use of speakers that may be inside the truck and proximate to the containers.

At block 130, transported water may be provided to a retail environment. In the retail environment, positive stimuli may be introduced, including, for example, audible, physical or sensory stimuli having positive connotations. In one embodiment, as described with reference to FIG. 5, a retail display may be employed in the marketing of products such as bottled water. The retail display may be adapted to store, display or hold containers of water, such as bottled water packaged for retail purchase. The retail display may include a visual stimulus in the form of words, such as “love”, “happy” and “gratitude”, and may additionally include an audible stimulus such as music, chanting, blessings or positive words that may be provided by use of speakers, for example.

At block 132, positive stimuli, including audible, physical or sensory stimuli, for example, may be introduced during the consumption process. In one embodiment, as described with reference to FIG. 9, a bottle that may be adapted to contain water may include a visual stimulus in the form of words, such as “love”, and “gratitude” that may be formed on one or more surfaces of the bottle. The bottle may additionally include a cap that may additionally have a visual stimulus such as words formed thereon, and may be adapted to produce an audible stimulus such as music, chanting, blessings or positive words by use of an audio system formed integrally with the cap. The audio system may be activated when the cap is removed from the bottle, for example.

In the preceding description, various aspects of claimed subject matter have been described. For purposes of explanation, systems and configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method, comprising:
employing at least two forms of positive stimulus during a plurality of phases of marketing of a water product.

2. The method of claim 1, wherein the marketing process comprises at least one of: production, packaging, distribution, sales and/or consumption.

3. The method of claim 1, wherein the at least two forms of positive stimulus comprise two or more of: an audible, visual and sensory stimulus.

4. The method of claim 1, further comprising,
employing at least two forms of positive stimulus during the packaging, distribution, and sales of a water product.

5. The method of claim 1, wherein the water product comprises at least one product selected from the group consisting of: bottled water, water-based beverages, and food.

6. The method of claim 1, wherein employing at least two forms of positive stimulus comprises:
providing an audible stimulus proximate to the water products; and
disposing symbols having a positive connotation on the water products.

7. The method of claim 1, wherein providing at least one form of positive stimulus comprises:
providing an activatible audible stimulus on a water bottle.

8. The method of claim 1, wherein the water product is adapted to be employed in a use selected from the group consisting of: drinking, sauna, steam room, swimming pool, irrigation, bathing, formation of ice, and watering of plants and/or animals.

9. An apparatus, comprising:
a water bottle, including a bottle surface having at least one symbol having a positive connotation formed on the bottle surface; and
a pressure sensitive cap, wherein the pressure sensitive cap Is adapted to produce an audible stimulus having a positive connotation in response to removal from the bottle.

10. The apparatus of claim 9, wherein the at least one symbol comprises a word.

11. The apparatus of claim 9, wherein the audible stimulus comprises music.

12. The apparatus of claim 9, wherein the pressure sensitive cap further comprises an activatible audio component adapted to produce an audible stimulus.

13. An apparatus, comprising:
a drinking glass holder, wherein the drinking glass holder is adapted to produce an audible stimulus in response to removal of a drinking glass from the holder.

14. The apparatus of claim 13, wherein the drinking glass holder comprises a pressure sensitive base.

15. The apparatus of claim 14, wherein the pressure sensitive base activates an audio component in response to removal of a drinking glass from the base.

16. The apparatus of claim 14, wherein the pressure sensitive base includes at least one word disposed on the base.

17. A system, comprising:
a bottling facility, adapted to employ a water bottling process to bottle water;
an audio source disposed proximate to water being bottled; and
a labeler adapted to dispose a visual stimulus on bottles during the water bottling process.

18. The system of claim 17, wherein the audio source is adapted to produce an audible stimulus.

19. The system of claim 18, wherein the audible stimulus comprises music.

20. The system of claim 18, wherein the audible stimulus comprises spoken words.

21. The system of claim 17, wherein the visual stimulus comprises symbols.

22. The system of claim 17, wherein the visual stimulus comprises words.

23. An apparatus, comprising:
means for packaging a water product; and
means for providing a plurality of positive stimuli during the packaging.

24. The apparatus of claim 23, wherein the means for packaging comprises means for bottling a water product.

25. The apparatus of claim 23, wherein the means for providing a plurality of positive stimuli comprises means for providing at least two forms of positive stimulus selected from the group consisting of: an audible, visual and sensory stimulus.

26. The apparatus of claim 23, wherein the means for providing a plurality of positive stimuli comprises:
means for providing music; and
means for disposing a positive stimulus on a package containing the water.
